(19) United States
(12) Patent Application Publication
(10) Pub. No.: US 2026/0261154 A1
(43) Pub. Date: Sep. 3, 2026

(54) Frequency Negotiation for a Wireless Power System

(71) Applicant: Apple Inc., Cupertino, CA (US)

(72) Inventors: Zaid A. AbuKhalaf, San Diego, CA (US); Alin I. Gherghescu, Campbell, CA (US)

(21) Appl. No.: 19/442,583

(22) Filed: Jan. 7, 2026

Related U.S. Application Data
(60) Provisional application No. 63/913,818, filed on Nov. 7, 2025.
(60) Provisional application No. 63/876,619, filed on Sep. 5, 2025.
(60) Provisional application No. 63/765,244, filed on Feb. 28, 2025.

(51) Int. Cl. H02J 50/80; H02J 7/90; H02J 50/10; H02J 50/90; H02J 107/20

(52) U.S. Cl. CPC H02J 50/80; H02J 7/971; H02J 50/10; H02J 50/90; H02J 2107/20; H02J 2207/20

(57) ABSTRACT

A wireless power system may include a power transmitting device for transmitting wireless power to a power receiving device. The power transmitting device may be operable in accordance with a first power profile that delivers wireless power at a first wattage using only a first frequency or a second power profile that delivers wireless power at a second wattage greater than the first wattage using the first frequency and/or a second frequency greater than the first frequency. The power receiving device can determine that the power transmitting device is capable of transmitting wireless power at multiple frequencies during operation in the second power profile, select a particular frequency from the multiple frequencies, and send a request to the power transmitting device requesting the power transmitting device to transmit wireless power at the particular frequency.

This application claims the benefit of U.S. provisional patent application No. 63/913,818, filed November 7, 2025, U.S. provisional patent application No. 63/876,619, filed September 5, 2025, and U.S. provisional patent application No. 63/765,244, filed February 28, 2025, which are hereby incorporated by reference herein in their entireties.

### FIELD

This relates generally to power systems and, more particularly, to wireless power systems for charging electronic devices.

### BACKGROUND

In a wireless power transfer system, a wireless power transmitting device transmits wireless power to a wireless power receiving device. The wireless power receiving device charges a battery and/or powers components using the wireless power. The wireless power receiving device may communicate with the wireless power transmitting device to control wireless power transfer operations.

### SUMMARY

An aspect of the disclosure provides a power receiving device adapted to receive wireless power from a power transmitting device. The power receiving device includes: a wireless power transfer coil configured to receive wireless power from the power transmitting device, where the power transmitting device implements a wireless power transfer protocol defining a first power profile and a second power profile, and where the power transmitting device transfers wireless power at a first wattage during operation under the first power profile and transfers wireless power at a second wattage greater than the first wattage during operation under the second power profile; a rectifier circuit coupled to the wireless power transfer coil and configured to output a corresponding rectified voltage; and control circuitry configured to: in response to determining that the power transmitting device is capable of transmitting wireless power at multiple frequencies during operation under the second power profile, select a particular frequency from the multiple frequencies and send a request to the power transmitting device requesting the power transmitting device to transmit wireless power at the particular frequency, where the particular frequency is selected according to a geographic assignment for the power receiving device.

An aspect of the disclosure provides a method of operating a power receiving device adapted to receive wireless power from a power transmitting device. The method includes: with a wireless power transfer coil, receiving wireless power from the power transmitting device, where the power transmitting device implements a wireless power transfer protocol defining a first power profile and a second power profile, and where the power transmitting device transfers wireless power at a first wattage during operation under the first power profile and transfers wireless power at a second wattage greater than the first wattage during operation under the second power profile; with a rectifier coupled to the wireless power transfer coil, outputting a corresponding rectified voltage; and in response to determining that the power transmitting device is capable of transmitting wireless power at multiple frequencies during operation under the second power profile, selecting a particular frequency from the multiple frequencies and sending a request to the power transmitting device requesting the power transmitting device to transmit wireless power at the particular frequency, where the particular frequency is selected according to a geographic assignment for the power receiving device.

An aspect of the disclosure provides control circuitry configured to be coupled to a wireless power transfer coil of an electronic device. The control circuitry is configured to: determine whether a power transmitting device is capable of transmitting wireless power to the wireless power transfer coil of the electronic device at multiple frequencies, where the power transmitting device implements a wireless power transfer protocol defining a first power profile and a second power profile, and where the power transmitting device transfers wireless power at a first wattage during operation under the first power profile and transfers wireless power at a second wattage greater than the first wattage during operation under the second power profile; and select a particular frequency from the multiple frequencies and send a request to the power transmitting device requesting the power transmitting device to transmit wireless power at the particular frequency in response to determining that the power transmitting device is capable of transmitting wireless power at the multiple frequencies during operation under the second power profile, where the particular frequency is selected according to a geographic assignment for the power receiving device.

An aspect of the disclosure provides a power transmitting device configured to transmit wireless power to a power receiving device. The power transmitting device may include a wireless power transfer coil configured to transmit wireless power to the power receiving device, an inverter configured to supply alternating-current drive signals to the wireless power transfer coil, and control circuitry configured to: transmit, using the wireless power transfer coil, a first data communication packet to the power receiving device, wherein the first data communication packet identifies a first maximum power transfer level and a pending power configuration change, within a predetermined duration of time from transmitting the first data communication packet, perform the pending power configuration change, and within the predetermined duration of time from transmitting the first data communication packet, transmit, using the wireless power transfer coil, a second data communication packet to the power receiving device, wherein the second data communication packet identifies a second maximum power transfer level that is greater than the first maximum power transfer level.

### BRIEF DESCRIPTION OF THE DRAWINGS

FIG. 1 is a schematic diagram of an illustrative wireless power system in accordance with some embodiments.

FIG. 2 is a circuit diagram of wireless power transmitting and receiving circuitry in accordance with some embodiments.

FIG. 3 is a table of illustrative wireless charging operating characteristics in accordance with some embodiments.

FIG. 4 is flowchart of illustrative techniques for operating a wireless power system in accordance with some embodiments.

FIG. 5 is a diagram of an illustrative extended capabilities packet in accordance with some embodiments.

FIG. 6 is a diagram of an illustrative frequency negotiation table in accordance with some embodiments.

FIG. 7 is a diagram showing illustrative operating characteristics of a wireless power system in accordance with some embodiments.

FIG. 8 is a diagram showing illustrative operations that can be performed when communication errors occur in accordance with some embodiments.

FIG. 9 is a diagram showing illustrative operating characteristics of a wireless power system in accordance with some embodiments.

FIG. 10 is a diagram showing illustrative operating characteristics of a wireless power system in accordance with some embodiments.

FIG. 11 is a diagram showing illustrative operating characteristics of a wireless power system accordance with some embodiments.

FIG. 12 is a diagram showing illustrative operating characteristics of a wireless power system in accordance with some embodiments.

FIG. 13 is a diagram showing illustrative operating characteristics of a wireless power system in accordance with some embodiments.

FIG. 14 is a state diagram showing illustrative power configurations for a wireless power transmitting device in accordance with some embodiments.

FIG. 15 is a diagram showing illustrative operating characteristics of a wireless power system in accordance with some embodiments.

FIG. 16 is a diagram of an illustrative extended capabilities packet in accordance with some embodiments.

FIG. 17 is a diagram showing illustrative operating characteristics of a wireless power system in accordance with some embodiments.

### DETAILED DESCRIPTION

A wireless power transfer system, sometimes referred to as a wireless power transmission system or wireless charging system, includes a wireless power transmitting device and a wireless power receiving device. The wireless power transmitting device (“PTX”) can transmit wireless power to the wireless power receiving device (“PRX”). Examples of wireless power transmitting devices include electronic devices such as wireless charging mats or pucks that couple to power adapters or other power source (such as by way of cables), battery packs, or more generally, other electronic devices with wireless power transmitting circuitry. A wireless power receiving device can use the wireless power received from a wireless power transmitting device for powering internal components and/or for charging an internal battery. Wireless power transfer operations are sometimes referred to as wireless power transmission operations or wireless charging operations. Examples of wireless power receiving devices include electronic devices such as cellular telephones, tablet computers, laptop computers, ear buds, battery cases for ear buds and other devices, tablet computer styluses (pencils) and other input-output devices, wearable devices, wristwatches, head-mounted devices, glasses, and so forth.

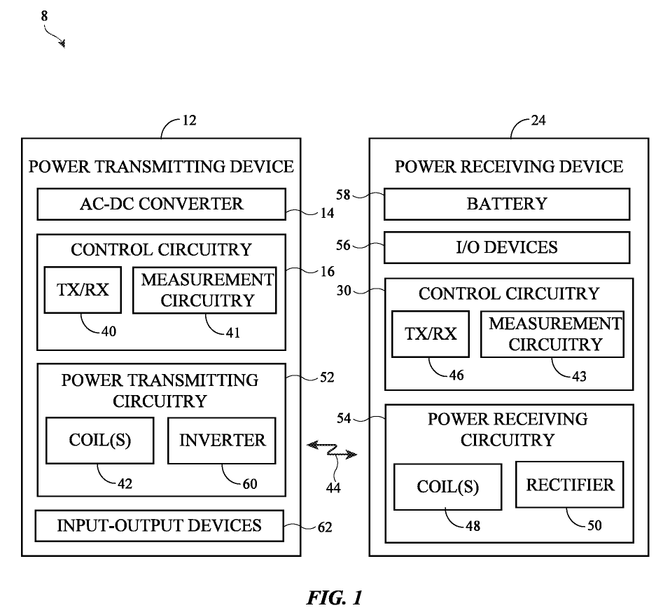

An illustrative wireless power transfer system 8 is shown in FIG. 1. As shown in FIG. 1, system 8 includes a wireless power transmitting device such as PTX 12 and includes a wireless power receiving device such as PRX 24. PTX 12 can include control circuitry 16, and PRX 24 can include control circuitry 30. Example control circuitries 16 and 30 control the operation of system 8. These control circuitries may include processing circuitry associated with microprocessors, power management units, baseband processors (e.g., a Bluetooth processing module, a near field communication or NFC controller, etc.), application processors, central processing units (CPUs), digital signal processors, microcontrollers, application-specific integrated circuits with processing circuits, and/or other processing circuitry.

The control circuitries 16 and 30 implements desired control and communications features in devices 12 and 24. For example, control circuitries 16 and 30 may be used in determining power transmission levels, processing sensor data and other data, handling negotiations between devices 12 and 24, sending and receiving in-band and out-of-band data, making measurements, and otherwise controlling the operation of system 8. The control circuitries in system 8 can use one or more of hardware (e.g., dedicated hardware or circuitry), firmware and/or software in performing operations. Firmware and/or software code may be stored on non-transitory computer readable storage media (e.g., tangible computer readable storage media), which may be updated from time to time. The firmware and/or software code may sometimes be referred to as software, program instructions, instructions, or code. The non-transitory computer readable storage media may include non-volatile memory such as non-volatile random-access memory (NVRAM), solid state storage, flash drives, or the like. Firmware and software stored on the non-transitory computer readable storage media may be executed on the processing circuitry of control circuitry 16 and/or 30.

Wireless power transmitting device 12 may be coupled to a wall outlet (e.g., an alternating current power source), may have a battery for supplying power, and/or may have another source of power. Device 12 may have an alternating-current (AC) to direct-current (DC) power converter such as AC-DC power converter 14 for converting AC power from a wall outlet or other power source into DC power. In some configurations, AC-DC power converter 14 may be provided in an enclosure (e.g., a power brick enclosure) that is separate from the enclosure of device 12 (e.g., a wireless charging puck enclosure or battery-powered electronic device enclosure) and a cable may be used to couple DC power from the power converter to device 12. DC power may be used to power control circuitry 16.

As shown in FIG. 1, wireless power transmitting device 12 also includes wireless power transmitting circuitry 52. Wireless power transmitting circuitry 52 may have switching circuitry, such as inverter 60 formed from transistor switches) that turn on and off, to create AC current signals that are provided to one or more wireless power transfer coils 42. PTX 12 can have one or more coils 42 depending on arrangement. In single-coil implementations, a single inverter 60 may drive a single coil 42. In multiple-coil implementations, one or more inverters 60 may drive coils 42. Multiple coils 42 may be arranged in a planar coil array (e.g., in configurations in which PTX 12 is a wireless charging mat) or may be arranged to form a cluster of coils (e.g., in configurations in which PTX 12 is a wireless charging puck).

During operation, control circuitry 16 works with wireless power transmitting circuitry 52, such as by controlling the switching sequence and timing of inverter 60, to generate AC signals that are appropriate for wireless power transfer, to transmit wireless power to wireless power receiving device 24. As AC current signals pass through one or more coils 42, the coils 42 produce corresponding electromagnetic field 44 in response to the AC current signals. Electromagnetic field (sometimes referred to as wireless power or wireless power signals) 44 can then induce a corresponding AC current to flow in one or more nearby receiver coils such as coil 48 of wireless power receiving device 24. The induced current is provided to rectifier 50, which includes transistor switches organized to convert the AC current into a DC output. In some implementations rectifier 50 is a synchronous rectification bridge network and the AC-to-DC converted current is used to power one or more loads in PRX 24. Examples of loads include I/O devices , battery 58, control circuitry 30, and other computing components (not shown in FIG. 1) such as application processors, displays, and so forth.

Control circuitry 16 in wireless power transmitting device 12 includes measurement circuitry 41, which comprises signal detection and signal measurement circuitries that facilitate feedback control of wireless power transfer system 8. For example, measurement circuitry 41 can be configured to detect external objects on the charging surface of the housing of PTX 12, and can facilitate the detection of whether a detected object is compatible with the wireless power transfer system or a foreign object to which wireless power transfer should be avoided. Measurement circuitry 41 can also measure or derive operating characteristics such as voltages and currents that are input to and output from the various power stages of PTX 12. For example, measurement circuitry 41 can assess how much power is being drawn from AC-DC converter 14 and how much power is being output by inverter 60. Measurement circuitry 41 can also detect the presence of one or more foreign objects, such as paper clips, keys, or other metallic objects. Control circuitry 30 in wireless power receiving device 24 includes measurement circuitry 43, which comprises signal detection and signal measurement circuitries that also facilitate feedback control of wireless power transfer system 8. For example, measurement circuitry 43 can be configured to monitor how much power is provided by rectifier 50 so that system 8 can account for the efficiency of power transfer between PTX 12 and PRX 24.

Examples of other operating conditions that may be measured and/or derived using measurement circuitries 41 and 43 include coil Q-factor measurements, coil inductance measurements, coupling coefficient measurements, operating temperatures, so forth. Using this information control circuitries 16 and/or 30 can characterize the operation of PTX 12 and PRX 24.

Control circuitry 16 in wireless power transmitting device 12 also includes wireless data transceiver (TX/RX) circuitry 40. TX/RX circuitry can use coil(s) 42 to transmit data communications signals to wireless transceiver circuitry 46 that are received by wireless transceiver circuitry 46 using coil(s) 48. Suitable modulation schemes may support data communications between wireless power transmitting device 12 and wireless power receiving device 24. For example, in the Qi standard promulgated by the Wireless Power Consortium (WPC), a wireless power transmitting device uses frequency-shift keying (FSK) modulation of its inverter output signal to convey in-band data to a wireless power receiving device. The Qi standard also specifies that a wireless power receiving device uses amplitude-shift keying (ASK) to convey in-band data to a wireless power transmitting device. These data signals, which are conveyed using the wireless power signals, are referred to as “in-band” data communication signals. In this example, TX/RX circuitry 40 is configured to encode outbound data into ASK modulations and to decode inbound data using FSK de-modulation. In other implementations, “out-of-band” channels such as NFC and/or Bluetooth may be used.

During wireless power transfer operations, wireless power transmitting circuitry 52 supplies AC current signals to one or more coils 42 at a given wireless power transmission frequency, sometimes referred to herein as an operating frequency or active frequency. Devices operating under the Qi wireless power transfer standard established by the Wireless Power Consortium generally operate between 110-205kHz and/or at specific frequencies such as 360 kHz. Other operating frequencies are possible, with certain implementations at, for example 128 kHz, 326 kHz, 1.78 MHz, 13.56 MHz, and so forth. As a further example, the Power Matters Alliance (PMA) wireless charging standard operates between 277-357 kHz. In some implementations, the operating frequency is negotiated during startup communications between PTX 12 and PRX 24. In some implementations, the operating frequency can vary during a power transfer session. In other implementations, the operating frequency is fixed. Wireless power transmitting device 12 may transmit wireless power to power receiving device 24 in accordance with one or more wireless charging standards, including the WPC and/or PMA examples above. If desired, other wireless charging interface definitions can be implemented, including proprietary protocols.

The example in FIG. 1 of PTX 12 transmitting wireless power and PRX 24 receiving wireless power is merely illustrative. PTX 12 may optionally be capable of receiving wireless power transfer signals using coil(s) 32 and PRX 24 may optionally be capable of transmitting wireless power transfer signals using coil(s) 48. When a device is capable of both transmitting and receiving wireless power transfer signals, the device may include both an inverter and a rectifier.

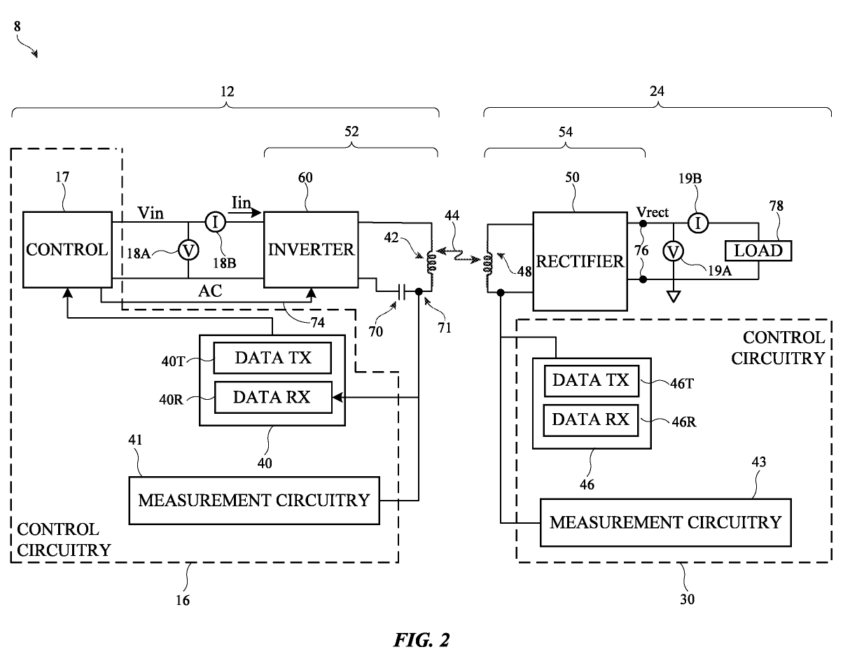

FIG. 2 is a circuit diagram of wireless power transmitting and receiving circuitry in accordance with some embodiments. As shown in FIG. 2, control circuitry 16 can include transceiver circuitry 40, measurement circuitry 41, and a controller 17. Controller 17 can be configured to provide a supply voltage such as supply voltage Vin for powering inverter 60. Controller 17 can also be configured to provide control signals to a control input of inverter 60, via path 74. PTX 12 can optionally include one or more voltage sensors such as voltage sensor 18A and one or more current sensors such as current sensor 18B. Voltage sensor 18A and current sensor 18B, although shown as being separate from measurement circuitry 41, can sometimes be considered part of measurement circuitry 41. Voltage sensor 18A may be configured to measure a voltage level for the inverter supply voltage Vin, whereas current sensor 18B may be configured to measure a current level for an inverter current Iin flowing into or through inverter 60. Inverter 60 can output drive signals onto wireless power transfer coil 42. Wireless power transfer coil 42 can be coupled in series with a capacitor 70. Transceiver circuitry 40 can have an input coupled to a node 71 disposed between capacitor 70 and coil 42. Measurement circuitry 41 can have an input coupled to node 71. Such connection is illustrative. If desired, transceiver circuitry 40 and/or measurement circuitry 41 can have inputs coupled to other nodes within power transmitting circuitry 52.

At PRX device 24, control circuitry 30 can include transceiver circuity 46 and measurement circuitry 43. Wireless power transfer coil 43 can be coupled to inputs of rectifier 50. Rectifier 50 can have outputs 76 at which a rectified voltage Vrect is produced. The rectified voltage Vrect can be proved to load 78 for powering load 78. PRX 24 can optionally include one or more voltage sensors such as voltage sensor 19A and one or more current sensors such as current sensor 19B. Voltage sensor 19A and current sensor 19B, although shown as being separate from measurement circuitry 43, can sometimes be considered part of measurement circuitry 43. Voltage sensor 19A may be configured to measure a voltage level of voltage Vrect output from rectifier 50, whereas current sensor 19B may be configured to measure a current level of an output current flowing into load 78. The voltage and current sensors within system 8 may be used to determine power levels within system 8. The specific locations of sensors 18A, 18B, 19A, and 19B (on the DC sides of inverter 60 and rectifier 50 respectively) in FIG. 2 are merely illustrative. In general, voltage and current sensors may be positioned at any desired positions within power transmitting circuitry 52 and power receiving circuitry 54 (e.g., on the AC sides of inverter 60 and rectifier 50, if desired). Transceiver circuitry 46 can have an input coupled to coil 48. Measurement circuitry 43 can have an input also coupled to coil 48. Such connection is illustrative. If desired, transceiver circuitry 46 and/or measurement circuitry 43 can have inputs coupled to other nodes within power receiving circuitry 54.

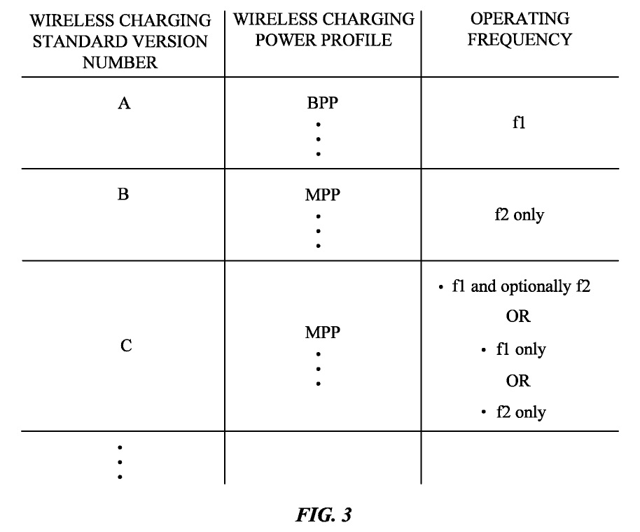

Wireless charging standards can develop over time leading to multiple specification versions or revisions. As such, different versions of a specification can exhibit different maximum power transfer capabilities, operating frequencies, communication protocol definitions, and other operating characteristics. The table of FIG. 3 illustrates an example combination of wireless power transfer standard versions, power profile definitions, and wireless power transfer transmission frequencies.

Example wireless charging standard version A supports a wireless charging power profile called baseline power profile, or BPP. BPP is defined in various versions of the Qi specifications, beginning with version 1.0, as supporting wireless power transfer operations up to 5W. A wireless power transmitting or receiving device supporting BPP is expected to operate in the 110-205 kHz operating frequency range. FIG. 3 highlights that a first frequency of interest, f1, exists within this range. In some implementations, frequency f1 is 128 kHz. In some wireless power transmitting or receiving devices supporting specification A, wireless power transfer occurs over the range of 110-205 kHz. In some wireless power transmitting or receiving devices supporting specification A, wireless power transfer occurs at a fixed frequency of f1 such as 128 kHz.

Example wireless charging standard version B, introduced subsequent to version A, supports a wireless charging power profile called magnetic power profile, or MPP. MPP is defined in the Qi standard, beginning with version 2.0, as supporting wireless power transfer operations beyond 5W, such as at 15W. FIG. 3 highlights that a wireless power transmitting or receiving devices supporting MPP as defined by specification version B expects to operate at a fixed frequency of f2. As an example, in version 2.0 of the Qi specification, f2 is defined as 360 kHz.

Example wireless charging standard version C also supports the MPP wireless charging power profile, and further, extends possible wireless charging operating frequencies to include f1 in addition to f2. In the illustrated example, f1 is the same frequency defined in version A of the standard, e.g., a frequency in the 110-205 kHz range such as 128 kHz. It should be understood more generally that version C can extend possible wireless charging operating frequencies to include other frequencies (f3) different than f1 and f2.

As can be seen in the table of FIG. 3, some wireless charging power profiles that are present across multiple versions of a standard specification, such as MPP, can change in their operation across those versions. For instance, a wireless power transmitter or receiver implementing version B of the MPP power profile should operate at f2, but a device implementing version C of the MPP power profile can elect to operate at f1 only, f2 only, or both. Stated differently, a wireless power transmitting device or a wireless power receiving device that is implementing MPP under specification version C can choose whether it wishes to engage in wireless power transfer under the MPP power profile at frequency f1 sometimes (or all of the time), and also whether it wishes to engage in wireless power transfer under the MPP power profile at frequency f2 sometimes (or all of the time). In contrast, a device implementing MPP under version B is restricted to wireless power transfer under the MPP power profile at frequency f2 only. These implementation choices may occur at design time and vary across device manufacturers. Alternatively or additionally, these implementation may permit a device to support multiple operating frequencies and for the device to choose, under different operating conditions, which operating frequency to use.

As electronic devices supporting wireless power transfer seek to interoperate in the field, it is desirable for the devices to negotiate for a compatible operating frequency such that wireless power transfer can proceed. In instances where multiple frequencies are possible, one frequency may be more desirable for efficiency and/or industry requirements. In such scenarios, it is desirable to provide a technique by which the wireless power transmitting device and the wireless power receiving device can negotiate to perform wireless power transfer using a suitable power profile and at a suitable frequency.

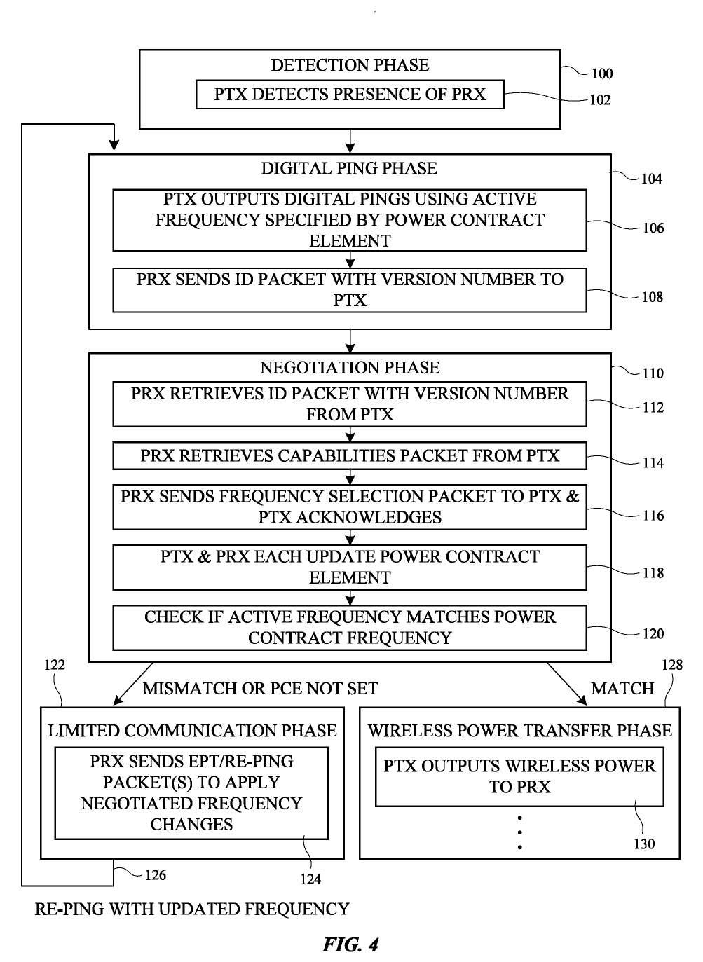

In accordance with an embodiment, FIG. 4 is flowchart of illustrative techniques for operating wireless power transmitting device 12 and wireless power receiving device 24 to perform frequency negotiations to provide improved wireless power transfer compatibility. As shown in FIG. 4, the wireless power transfer system can be configured to operate in various phases over time, including a detection phase 100, a digital ping phase 104, a negotiation phase 110, a wireless power transfer phase 128, and a limited communication phase 122.

During detection phase 100, wireless power transmitting device 12 can operate in an object detection mode and can detect the presence of a power receiving device 24 on its charging surface, at block 102. As an example, wireless power transmitting device 12 may use analog pings, as described in the Qi specification, to detect the presence of an object that is coupled to it. In other words, wireless power transmitting device 12 can detect whether a potential wireless power receiving device is present.

After wireless power transmitting device 12 detects the object, it proceeds to the digital ping phase 104. During digital ping phase 104, the wireless power transmitting device 12 outputs digital pings to communicate with wireless power receiving device 24, as shown by the operations of block 106. Digital pings are wireless signals sent by a wireless power transmitting device that is of sufficient bandwidth and duration to support in-band communications with a compatible wireless power receiving device. For example, as discussed in versions of the Qi specification, digital pings have longer pulse durations than the object detection analog pings (used at block 102), and provide sufficient energy to activate or otherwise power up one or more components within a compatible wireless power receiving device, like PRX 24. At blocks 106 and 108, PTX 12 and PRX 24 can convey data packets using FSK and/or ASK modulation of the digital ping signal. In some implementations, PTX 12 emits digital ping signals at the operating frequency intended by PTX 12. In implementations where multiple operating frequencies are possible, PTX 12 emits digital ping signals at one of those frequencies as a starting point for frequency negotiation. In some implementations, PTX 12 emits digital ping signals at a frequency that is optimized for digital pings and/or the anticipated data communications that occur during the digital ping phase.

A wireless power transmitting device can decide what frequency is to be used for digital pings based on power contract element that is managed internally within the device, such as by using control circuitry 16 (see FIGS. 1 and 2). As an example, in some implementations, PTX 12 may be assigned a default power contract element value of “0” during the manufacturing process. A PTX 12 having a power contract element of “0” may default to frequency f1 for purposes of digital pings. Alternatively, PTX 12 may be assigned a different power contract element value, such as a value of “1”. A PTX 12 seeing a power contract element of “1” may default to frequency f2 for purposes of digital pings. Such default values of the PTX power contract element are illustrative. If desired, the PTX power contract element can be set to other values during subsequent phases. Dynamic control of the power contract element allows wireless power transmitting devices, such as PTX 12 to move between two or more different digital ping frequencies.

During block 106, wireless power receiving device 24 can measure the digital ping frequency output from device 12 and can also manage a separate power contract element within PRX 24 using control circuitry 30 (see FIG. 1). For example, if PRX 24 detects that the digital ping frequency is initialized to frequency f1, its power contract element may have a default value of “0,” indicating that the active frequency is not set. If PRX 24 detects that the digital ping frequency is initialized to frequency f2, its power contract element may have a default value of “1,” indicating that the active frequency is set to f2. Such default values of the PRX power contract element are illustrative. If desired, the PRX power contract element can be set to other values during subsequent phases. Dynamic control of the PRX power contract element allows device 24 to move between two or more different active frequencies.

During block 108 of the digital ping phase 104, power receiving device 24 can send an identification (ID) packet with its wireless charging standard version number to wireless power transmitting device 12. After receiving the ID packet and identifying the wireless charging standard version number of device 24, device 12 can then determine how to behave in response.

During the negotiation phase 110, power receiving device 24 can retrieve an identification (ID) packet from wireless power transmitting device 12 (see block 112). For instance, device 24 can send a request for an ID packet to PTX 12, and PTX 12 can then respond by sending an ID packet to PRX 24. Such ID packet sent from device 12 can include the wireless charging standard version number of device 12. After block 112, device 12 now knows the wireless charging standard version number of device 24, and vice versa.

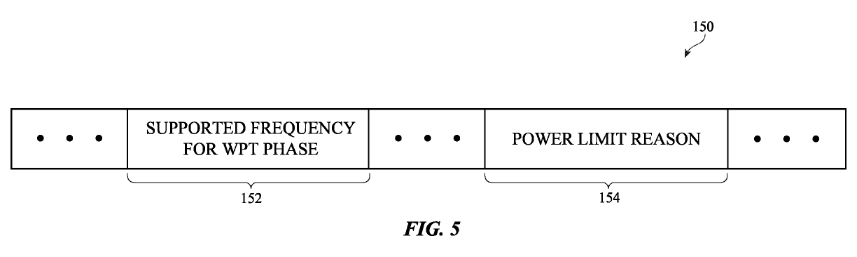

During the operations of block 114 of the negotiation phase, wireless power receiving device 24 can retrieve a capabilities packet from wireless power transmitting device 12. For instance, device 24 can send a request for a capabilities packet to device 12, and device 12 can then respond by sending a capabilities packet to device 24. FIG. 5 is a diagram of an illustrative capabilities packet 150. As shown in FIG. 5, capabilities packet 150 can include at least a first field 152 listing one or more supported frequencies for the active wireless power transfer phase and a second field 154 providing a power limit reason. Capabilities packet 150 may sometimes be referred to as an extended power transmitter extended capabilities (ECAP) packet.

Power transmitting device 12 may know, a priori, what wireless power transfer frequency or frequencies it is to support. Based on this information, PTX 12 can populate field 152 of capabilities packet 150. For example, field 152 of capabilities packet 150 can specify whether wireless power transfer at frequency f1 is supported, whether wireless power transfer at frequency f2 is supported, and/or whether wireless power transfer at other frequences is supported by the power transmitting device 12. A power transmitting device 12 that supports wireless power transfer at multiple active frequencies (see, e.g., MPP version number C in FIG. 3 supporting at least frequencies f1, f2, and/or other frequencies) is operable to provide different corresponding wireless power transfer wattages. For example, an active frequency f1 at device 12 can produce a first wireless power transfer wattage, whereas an active frequency f2 that is greater than f1 at device 12 can produce a second wireless power transfer wattage greater than the first wireless power transfer wattage. Field 12 is a supported frequency field, sometimes called a frequency mask. It can be implemented as a data packet byte comprising at least two bits. A first bit can carry a Boolean value specifying whether wireless power transfer at a first frequency, e.g., f1 is supported. A second bit can carry a Boolean value specifying whether wireless power transfer at a second frequency, e.g., f2 is supported.

In certain situations, a power transmitting device 12 may decide to transfer wireless power at a certain wattage that is less than its maximum capable wireless power transfer wattage. Field 154 of capabilities packet 150 can optionally provide a reason why device 12 is outputting a wattage that is less than its maximum wireless power transfer wattage. Field 154 is thus sometimes referred to herein as a power limit reason. Field 154 can be set to a predetermined value if the power limit reason is due to the selected operating frequency. For instance, if device 12 is transmitting at the first power transfer wattage because the power receiving device 24 has selected the lower active frequency f1, then device 12 can set the power limit reason field 154 to the predetermined value to inform device 24 that the reason for limiting the wireless power transfer wattage is due to the selected operating frequency. Providing such power limit reason in capabilities packet 150 can help device 24 subsequently determine what frequency to request for wireless power transfer.

As an example, PRX 24 can prefer operating at one frequency over another based on its operating location. In some locations, PRX 24 prefers wireless power transfer at frequency f1. In some locations, PRX 24 prefers wireless power transfer at frequency f2. Power receiving device 24 may determine its geographic assignment using a global positioning system (GPS) component, a global navigation satellite system (GLONASS) component, and/or other positioning, navigation, or localization subsystem that can be included as part of I/O device 56 in FIG. 1. Additionally or alternatively, power receive device 24 may determine its geographic assignment by looking up a setting, whether in hardware, firmware, software, or manufacture. Such coding can, for example, be stored on non-volatile memory that can be included as part of control circuitry 30 in FIG. 1. In some implementations, the part number, model number, and/or stock keeping unit (SKU) can be used to help distinguish between different models, configurations, and/or regional versions having varying operating frequency preferences.

As another example, device 24 can subsequently decide to switch to the higher frequency f1 to take advantage of the higher available wireless power transfer capability of device 12, if such frequency is allowed by the PTX power contract element. Capabilities packet 150 can optionally include other power information. Capabilities packet 150 is sometimes referred to as an power transmitter extended capabilities packet. The operations of block 114 can thus optionally be omitted if device 12 or 24 is operating using version number A or B.

During the operations of block 116 of the negotiation phase, power receiving device 24 can send a frequency selection packet to power transmitting device 12. Such frequency selection packet transmitted by device 24 can include a frequency selector field. The frequency selector field can have a first value (e.g., “0”) if the requested frequency is not set, a second value (e.g., “1”) if the requested frequency for wireless power transfer is equal to frequency f2, a third value (e.g., “2”) if the requested frequency for wireless power transfer is equal to frequency f1, and other values if the requested frequency for wireless power transfer is some frequency other than f1 or f2. In response to receiving such frequency selection packet from device 24, power transmitting device 12 can send an acknowledgement (ACK) back to device 14, indicating that device 12 accepts the frequency specified by the frequency selector field. Alternatively, if the frequency specified in the frequency selector field is not supported by device 12, device 12 can respond by sending a negative acknowledge (NACK) back to device 24.

For example, a power receiving device 24 operating in accordance with wireless charging standard version number B might always request for frequency f2 (see, e.g., FIG. 3). As another example, a power receiving device 24 operating in accordance with wireless charging standard version number C can optionally request for frequency f1 or frequency f2 depending on what the power transmitting device 12 is capable of supporting. Power receiving device 24 may ascertain what frequency or frequencies the power transmitting device 12 supports by examining, for example, the capabilities packet received from device 12 during block 114. If device 12 supports multiple frequencies, then device 24 can select from among one of the multiple supported frequencies. For instance, if device 12 supports both frequencies f1 and f2, device 24 might request a lower active frequency of f1 due to operating preferences. If device 12 supports only one frequency, then device 24 can either select the only available frequency, can decide not to charge, or can fall back to operating in accordance with the older wireless charging standard version number A.

In general, a power transmitting device 12 can be operable to provide wireless power transfer at a first frequency set (e.g., one or more frequencies), whereas a power receiving device 24 can be operable to receive wireless power at a second frequency set (e.g., one or more frequencies). The first frequency set supported by device 12 may only partially overlap with the second frequency set supported by device 24, may entirely overlap (coincide) with the second frequency set, or may be non-overlapping with the second frequency set. In any case, power receiving device 24 can be configured to select a wireless power transfer frequency based on the first and second frequency sets to optimize for the highest wireless power transfer wattage (e.g., using the highest available frequency or a lower frequency if the highest frequency is not preferred) or can fall back to a lower wireless power transfer wattage if the higher (or highest) wireless power transfer wattage is not preferred.

During the operations of block 118 of the negotiation phase, devices 12 and 24 can each update their respective power contract element based on the value specified in the frequency selector field of the frequency selection packet. For instance, power transmitting device 12 can update the value of the PTX power contract element based on the value of the frequency selector field (e.g., the PTX power contract element value is set equal to the frequency selector field value). Similarly, power receiving device 12 can update the value of the PRX power contract element based on the value of the frequency selector field (e.g., the PRX power contract element value is set equal to the frequency selector field value). Updating the power contract elements in this way ensures that the power contract elements in device 12 and 24 are synchronized to the same value.

During the operations of block 120, devices 12 and 24 can each check whether the active frequency matches a power contract frequency specified by the power contract element. As described above in connection with block 116, the PTX/PRX power contract element can be equal to a first value (e.g., “0”) when the active frequency is not yet set, a second value (e.g., “1”) if the requested frequency for wireless power transfer is equal to frequency f2, and a third value (e.g., “2”) if the requested frequency for wireless power transfer is equal to frequency f1. The frequency corresponding to each power contract element value is sometimes referred to and defined herein as a “power contract frequency.” In this example, a power contract element having a value of “1” corresponds to a power contract frequency equal to f2 (e.g., 360 kHz), whereas a power contract element having a value of “2” corresponds to a power contract frequency equal to f1 (e.g., 128 kHz).

If the current active frequency of system 8 matches the power contract frequency, processing can proceed to the wireless power transfer phase 128. During block 130 of phase 128, power transmitting device 12 can output wireless power to power receiving device 24. Such an operating mode of device 12 during which device 12 transfers wireless power to device 24 is sometimes referred to as an active wireless power transfer mode. During the active wireless power transfer phase 128, power receiving circuitry 54 of device 24 can convert the wireless power signals into corresponding output voltage Vrect, which can be used to charge a battery within device 24 (see, e.g., Vrect at the output of rectifier 50 in FIG. 2 and battery 58 in FIG. 1).

If the current active frequency of system 8 does not match the power contract frequency or if the power contract element has not yet been set (e.g., if the power contract element still has a value of “0”), devices 12 and 24 may proceed to a limited communication phase 122. During the limited communication phase 122, device 12 does not charge device 24 (e.g., power related packets are not allowed to be communicated between devices 12 and 24 during phase 122). During limited communication phase 122, power receiving device 24 can send an end power transfer (EPT) packet for ending wireless power transfer, as shown by the operations of block 124. During block 124, power receiving device 24 can also send a re-ping packet to device 12, which can be a command that directs device 12 to proceed back to the digital ping phase 104, as shown by loopback path 126. Operated in this way, device 12 can restart outputting digital pings with a new active frequency as specified by the power contract element updated during block 118. The EPT and re-ping packets can be sent as separate packets or as a single combined packet to device 12.

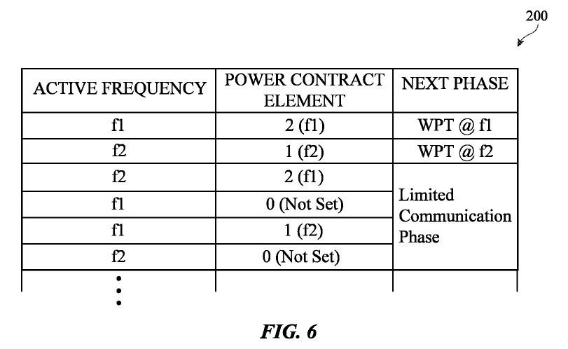

The frequency checking performed during block 120 to determine the next phase of operation can be summarized in the frequency negotiation truth table of FIG. 6. As an example, if the current active frequency of device 12 is equal to f1 and the power contract element has a value of “2,” which corresponds to a requested power contract frequency of f1, then the next phase will be the active wireless power transfer phase 128 transmitting power at frequency f1. As another example, if the current active frequency of device 12 is equal to f2 and the power contract element has a value of “1,” which corresponds to a requested power contract frequency of f2, then the next phase will be the active wireless power transfer phase 128 transmitting power at frequency f2.

As another example, if the current active frequency of device 12 is equal to f2 and the power contract element has a value of “2,” which corresponds to a requested power contract frequency of f1, then the next phase will be the limited communication phase 122. As another example, if the current active frequency of device 12 is equal to f1 and the power contract element has a value of “0,” which means that the power contract element has not been set, then the next phase will be the limited communication phase 122. As another example, if the current active frequency of device 12 is equal to f1 and the power contract element has a value of “1,” which corresponds to a requested power contract frequency of f2, then the next phase will be the limited communication phase 122. As another example, if the current active frequency of device 12 is equal to f2 and the power contract element has a value of “0,” which means that the power contract element has not been set, then the next phase will also be the limited communication phase 122.

If desired, wireless power transmitting device 12 may select a frequency to be used for the digital ping phase, negotiation phase, and/or wireless power transfer phase based on its operating location. PTX 12 may determine its geographic assignment using a global positioning system (GPS) component, a global navigation satellite system (GLONASS) component, and/or other positioning, navigation, or localization subsystem that can be included as part of input-output devices 62 in FIG. 1. Additionally or alternatively, power transmitting device 12 may determine its geographic assignment by looking up a setting, whether in hardware, firmware, software, or manufacture. Such coding can, for example, be stored on non-volatile memory that can be included as part of control circuitry 16 in FIG. 1. In some implementations, the part number, model number, and/or SKU can be used to help distinguish between different models, configurations, and/or regional versions having varying operating frequency preferences.

In some locations (e.g., countries or jurisdictions where power transmission at only frequency f1 is approved), PTX 12 may prefer to transfer wireless power at frequency f1. In some locations (e.g., countries or jurisdictions where power transmission at frequencies f1 and f2 are approved), PTX 12 may prefer to transfer wireless power transfer at frequency f2. PTX 12 may therefore use the determined operating location to select a frequency for wireless power transfer. This type of operating scheme may be particularly useful when PTX 12 has bidirectional charging capabilities (e.g., PTX 12 may be a cellular telephone or other electronic device that is capable of both transmitting wireless power and receiving wireless power).

As an example, PTX 12 may be a cellular telephone with bidirectional charging capabilities. The cellular telephone may include a global positioning system (GPS) component that allows the cellular telephone to determine its operating location. The cellular telephone may support wireless power transfer at both f1 and f2. In response to detection of a power receiving device, the cellular telephone may determine its operating location. When the cellular telephone determines that its operating location is a country or jurisdiction where power transmission at only f1 is approved, the cellular telephone may transmit wireless power to the power receiving device at f1. When the cellular telephone determines that its operating location is a country or jurisdiction where power transmission at both f1 and f2 are approved, the cellular telephone may transmit wireless power to the power receiving device at f2.

When an electronic device has bidirectional charging capabilities, the electronic device may determine its operating location in response to detection of an additional electronic device. When the electronic device operates as a wireless power receiving device, the electronic device may transmit a request to the additional electronic device for a wireless power transmission frequency of f1 in response to determining that its operating location is a country or jurisdiction where power transmission at only f1 is approved. When the electronic device operates as a wireless power receiving device, the electronic device may transmit a request to the additional electronic device for a wireless power transmission frequency of f2 in response to determining that its operating location is a country or jurisdiction where power transmission at both f1 and f2 is approved. When the electronic device operates as a wireless power transmitting device, the electronic device may transmit wireless power to the additional electronic device at f1 in response to determining that its operating location is a country or jurisdiction where power transmission at only f1 is approved. When the electronic device operates as a wireless power transmitting device, the electronic device may transmit wireless power to the additional electronic device at f2 in response to determining that its operating location is a country or jurisdiction where power transmission at both f1 and f2 is approved.

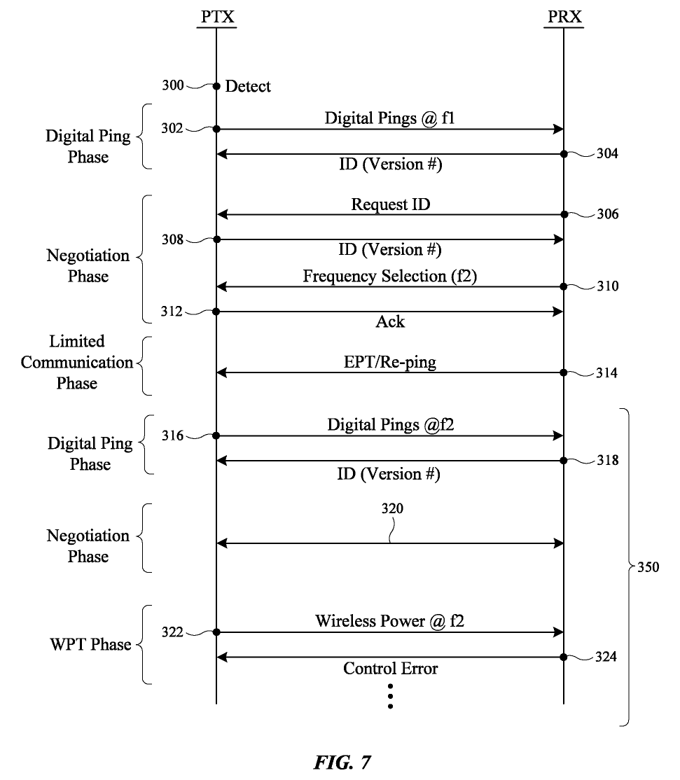

FIGS. 7-13 are diagrams illustrating various scenarios that might occur between different versions of devices 12 and 24. FIG. 7 is a diagram showing illustrative operations that can be performed between a power transmitting device 12 having wireless charging standard version number C and supporting wireless power transfer at frequency f2 and optionally frequency f1 and a power receiving device 24 having wireless charging standard version number B and supporting wireless power transfer at only frequency f2. Here, devices 12 and 24 can perform frequency negotiations that ultimately result in the system reaching the active wireless power transfer phase using the common frequency f2 that is supported by both devices.

At block 300, the PTX device 12 can detect the presence of the PRX device 24. Block 300 of FIG. 7 may thus correspond to the operations of block 102 in FIG. 4.

At block 302, the PTX device 12 can output digital pings that are modulated at an active frequency. The active frequency can be initialized to frequency f1, assuming no prior frequency negotiation has been performed with device 24. In such scenario, the power contract element of each device can be set to a default value of “0.” Block 302 can thus correspond to the operations of block 106 of FIG. 4. At block 304, device 24 can send an ID packet that includes its wireless charging standard version number to device 12. In this example, device 24 can have a wireless charging standard version number B (see FIG. 3). Block 304 can thus correspond to the operations of block 108 of FIG. 4. Blocks 302 and 304 can thus be performed during the digital ping phase.

At block 306, the PRX device 24 can send a packet requesting an ID packet from the PTX device 12. At block 308, device 12 can respond by sending its ID packet that includes its wireless charging standard version number to device 24. In this example, device 12 can have a wireless charging standard version number C (see FIG. 3). Blocks 306 and 308 may correspond to the operations of block 112 in FIG. 4. In this example, block 114 can be skipped since device 24 is not operating in accordance with wireless charging standard version number C.

At block 310, device 24 can send a frequency selection packet to device 12. Here, the frequency selection packet sent by device 24 may include a frequency selector field having the second value (e.g., “1”), corresponding to a requested frequency of f2, since it is the only frequency supported by version B. At block 312, device 12 can send an acknowledgement back to device 24, indicating that device 12 has accepted the frequency specified by the frequency selector field. Blocks 310 and 312 may correspond to the operations of block 116 in FIG. 4. Blocks 306, 308, 310, and 312 can thus be performed during the negotiation phase.

Although not explicitly shown FIG. 7, devices 12 and 24 can then perform the operations of blocks 118 and 120 in FIG. 4 at the end of the negotiation phase. Here, both devices 12 and 24 will update their power contract element to a value of “1” as specified by the frequency selector field, which corresponds to a power contract frequency of f2. Both devices 12 and 24 can then check whether the current active frequency matches the power contract frequency. Since the current active frequency is still f1 by default and since the power contract frequency is now set to f2, the active frequency will be mismatched from the power contract frequency. As a result, the system can then proceed to the limited communication phase.

At block 314, the PRX device 24 may send one or more EPT/re-ping packet(s) to the PRX device 12. This will terminate the current wireless power transfer session and direct device 12 to restart the digital ping phase using an updated active frequency. Block 314 may thus correspond to the operations of block 124 during the limited communication phase.

At block 316, the PTX device 12 can output digital pings that are modulated at an updated active frequency. The active frequency will now be set equal to f2 in accordance with the updated power contract element. Block 316 can thus correspond to the operations of block 106 of FIG. 4. At block 318, device 24 can again send an ID packet that includes its wireless charging standard version number to device 12. Block 318 can thus correspond to the operations of block 108 of FIG. 4. Blocks 316 and 318 can thus be performed during the digital ping phase.

At block 320, the various negotiation operations described in connection with blocks 112-120 in FIG. 4 and blocks 306-312 in FIG. 7 can be performed. The details of these blocks need not be reiterated to avoid obscuring the present description. This time around, the active frequency has now been updated to f2, which now matches with the power contract frequency in both devices. As a result, the system is now allowed to enter the active wireless power transfer phase.

During the wireless power transfer phase, PTX device 12 can output wireless power to PRX device 24 (see block 322). Block 322 may thus correspond to the operations of block 130 in FIG. 4. During the wireless power transfer phase, device 24 can also send one or more control error packets for adjusting the output power level of the wireless power transfer (see block 324). Additionally or alternatively, other types of control or data packets can be conveyed between devices 12 and 24 during the wireless power transfer phase to help optimize the wireless power transfer operation. In summary, devices 12 and 24 can perform frequency negotiations that ultimately result in the system reaching the active wireless power transfer phase using the common frequency f2 that is supported by both devices.

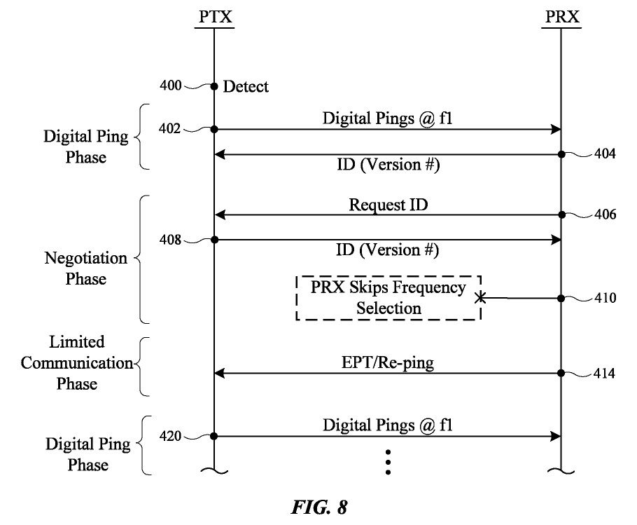

FIG. 8 is a diagram showing illustrative operations that can be performed when the scenario shown in FIG. 7 skips frequency negotiation due to a communications error in accordance with some embodiments. At block 400, the PTX device 12 can detect the presence of the PRX device 24. Block 400 of FIG. 8 may thus correspond to the operations of block 102 in FIG. 4.

At block 402, the PTX device 12 can output digital pings that are modulated at an active frequency. The active frequency can be initialized to frequency f1, assuming no prior frequency negotiation has been performed with device 24. In such scenario, the power contract element of each device can be set to a default value of “0.” Block 402 can thus correspond to the operations of block 106 of FIG. 4. At block 404, device 24 can send an ID packet that includes its wireless charging standard version number to device 12. In this example, device 24 can have a wireless charging standard version number B (see FIG. 3). Block 404 can thus correspond to the operations of block 108 of FIG. 4. Blocks 402 and 404 can thus be performed during the digital ping phase.

At block 406, the PRX device 24 can send a packet requesting an ID packet from the PTX device 12. At block 408, device 12 can respond by sending its ID packet that includes its wireless charging standard version number to device 24. In this example, device 12 can have a wireless charging standard version number C (see FIG. 3). Blocks 406 and 408 may correspond to the operations of block 112 in FIG. 4. In this example, block 114 can be skipped since device 24 is not operating in accordance with wireless charging standard version number C.

In the example of FIG. 4, the PRX device 24 might inadvertently skip the frequency selection block (see 410). Such omission might be due to a communications error. Without the frequency selection packet, the power contract element in both devices 12 and 24 will not be updated from their default value of “0.” Since the power contract element has not been set, the system will enter the limited communication phase in accordance with the truth table of FIG. 6.

At block 414, the PRX device 24 may send one or more EPT/re-ping packet(s) to the PRX device 12. This will terminate the current wireless power transfer session and direct device 12 to restart the digital ping phase using an updated active frequency. Block 414 may thus correspond to the operations of block 124 during the limited communication phase. Here, however, the active frequency will remain at the default value of f1 since the power contract element was not updated by a frequency selection packet.

At block 420, the PTX device 12 can output digital pings that are modulated again at an active frequency equal to f1. At this point, the subsequent blocks can follow the blocks shown in FIG. 7 (e.g., blocks 304-324) assuming no communications error or can follow the blocks shown in FIG. 8 (e.g., blocks 404-420) if the communications error continues to occur. In summary, the system can recover from a communications error if device 24 resumes the frequency selectin operation after a re-ping.

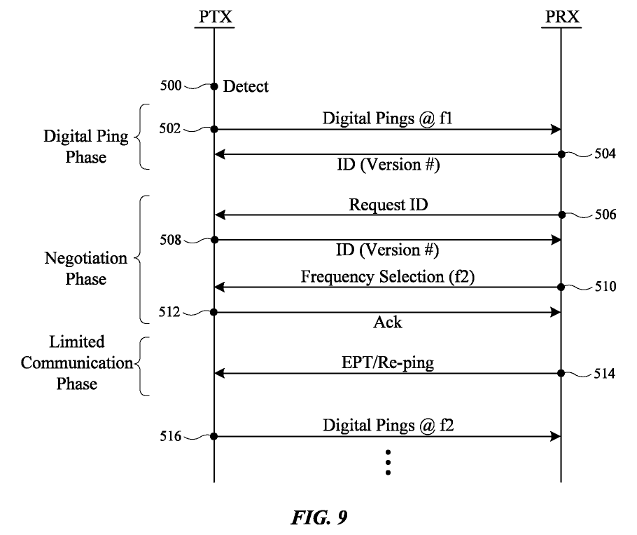

FIG. 9 is a diagram showing illustrative operations that can be performed between a power transmitting device 12 having wireless charging standard version number B and supporting wireless power transfer at frequency f2 and a power receiving device 24 having wireless charging standard version number C and supporting wireless power transfer at frequencies f1 and f2 in accordance with some embodiments. Here, devices 12 and 24 can perform frequency negotiations that ultimately result in the system reaching the active wireless power transfer phase using the common frequency f2 that is supported by both devices.

At block 500, the PTX device 12 can detect the presence of the PRX device 24. Block 500 of FIG. 7 may thus correspond to the operations of block 102 in FIG. 4.

At block 502, the PTX device 12 can output digital pings that are modulated at an active frequency. The active frequency can be initialized to frequency f1, assuming no prior frequency negotiation has been performed with device 24. In such scenario, the power contract element of each device can be set to a default value of “0.” Block 502 can thus correspond to the operations of block 106 of FIG. 4. At block 504, device 24 can send an ID packet that includes its wireless charging standard version number to device 12. In this example, device 24 can have a wireless charging standard version number C (see FIG. 3). Block 504 can thus correspond to the operations of block 108 of FIG. 4. Blocks 502 and 504 can thus be performed during the digital ping phase.

At block 506, the PRX device 24 can send a packet requesting an ID packet from the PTX device 12. At block 508, device 12 can respond by sending its ID packet that includes its wireless charging standard version number to device 24. In this example, device 12 can have a wireless charging standard version number B (see FIG. 3). Blocks 506 and 508 may correspond to the operations of block 112 in FIG. 4. In this example, block 114 can be skipped since device 12 is not operating in accordance with wireless charging standard version number C.

At block 510, device 24 can send a frequency selection packet to device 12. Here, the frequency selection packet sent by device 24 may include a frequency selector field having the second value (e.g., “1”), corresponding to a requested frequency of f2, since it is the only frequency supported by version B. At block 512, device 12 can send an acknowledgement back to device 24, indicating that device 12 has accepted the frequency specified by the frequency selector field. Blocks 510 and 512 may correspond to the operations of block 116 in FIG. 4. Blocks 506, 508, 510, and 512 can thus be performed during the negotiation phase.

Although not explicitly shown FIG. 7, devices 12 and 24 can then perform the operations of blocks 118 and 120 in FIG. 4 towards the end of the negotiation phase. Here, both devices 12 and 24 will update their power contract element to a value of “1” as specified by the frequency selector field, which corresponds to a power contract frequency of f2. Both devices 12 and 24 can then check whether the current active frequency matches the power contract frequency. Since the current active frequency is still f1 by default and since the power contract frequency is now set to f2, the active frequency will be mismatched from the power contract frequency. As a result, the system can then proceed to the limited communication phase.

At block 514, the PRX device 24 may send one or more EPT/re-ping packet(s) to the PRX device 12. This will terminate the current wireless power transfer session and direct device 12 to restart the digital ping phase using an updated active frequency. Block 514 may thus correspond to the operations of block 124 during the limited communication phase.

At block 516, the PTX device 12 can output digital pings that are modulated at an updated active frequency. The active frequency will now be set equal to f2 in accordance with the updated power contract element. Block 516 can thus correspond to the operations of block 106 of FIG. 4. At this point, the remaining blocks 350 of FIG. 7 (e.g., including blocks 318, 320, 322, and 324) can be performed to reach the active wireless power transfer phase. In summary, devices 12 and 24 can perform frequency negotiations that ultimately result in the system reaching the active wireless power transfer phase using the common frequency f2 that is supported by both devices. In the example of FIG. 9, the PRX device 24 selects a backward compatible operation since device 12 only supports frequency f2. Alternatively, device 24 can elect not to proceed with wireless power transfer if operation at frequency f2 is not preferred.

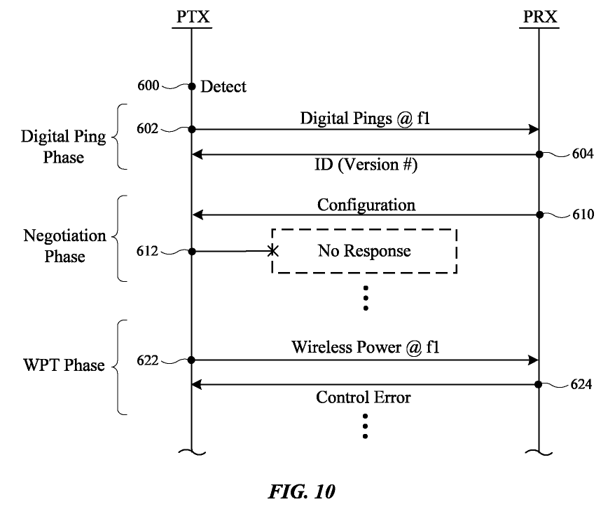

FIG. 10 is a diagram showing illustrative operations that can be performed between a PTX device 12 having wireless charging standard version number C and supporting wireless power transfer at only frequency f1 and a PRX device 24 having wireless charging standard version number B and supporting wireless power transfer at only frequency f2 in accordance with some embodiments. Device 12 having version number C might be limited to f2 operation due to geographical constraints. Device 24 can, however support wireless power transfer at frequency f1 when operating in accordance with the older wireless charging standard version number A.

At block 600, the PTX device 12 can detect the presence of the PRX device 24 on this charging surface. Block 600 of FIG. 10 may thus correspond to the operations of block 102 in FIG. 4.

At block 602, the PTX device 12 can output digital pings that are modulated at an active frequency. The active frequency can be initialized to frequency f1, assuming no prior frequency negotiation has been performed with device 24. In such scenario, the power contract element of each device can be set to a default value of “0.” Block 602 can thus correspond to the operations of block 106 of FIG. 4. At block 604, device 24 can send an ID packet that includes its wireless charging standard version number to device 12. In this example, device 24 can have a wireless charging standard version number B (see FIG. 3). Block 604 can thus correspond to the operations of block 108 of FIG. 4. Blocks 602 and 604 can thus be performed during the digital ping phase.

At block 610, the PRX device 24 can send a configuration packet asking the PTX device 12 to switch from operating in accordance with wireless charging standard version number A to wireless charging standard version number B. Here, device 12 knows that it is to default to operation at frequency f1 in accordance with version number B of device 24. As a result, device 12 can pretend to behave like a power transmitting device having the wireless charging standard version number A since device 24 does support f1 operation for version number A. To do so, device 12 will not respond to the configuration packet (see block 612). In the absence of receiving an acknowledgement to the configuration packet, both device 12 and device 24 can proceed with operation in accordance with wireless charging standard version number A. Blocks 610 and 612 can be considered part of the negotiation phase.

Here, the system can subsequently enter the active wireless power transfer phase in accordance with wireless charging standard version number A. During the wireless power transfer phase, PTX device 12 can output wireless power to PRX device 24 (see block 622). Block 622 may thus correspond to the operations of block 130 in FIG. 4. During the wireless power transfer phase, device 24 can also send one or more control error packets for adjusting the output power level of the wireless power transfer (see block 624). Additionally or alternatively, other types of control or data packets can be conveyed between devices 12 and 24 during the wireless power transfer phase to help optimize the wireless power transfer operation. In other words, device 12 can optionally decide to alter its behavior (e.g., by not responding to the configuration packet) to allow wireless charging using version number A when it prefers to transfer wireless power at frequency f1. Alternatively, device 12 can elect not to proceed with wireless power transfer due to preference for wireless power transfer at frequency f1.

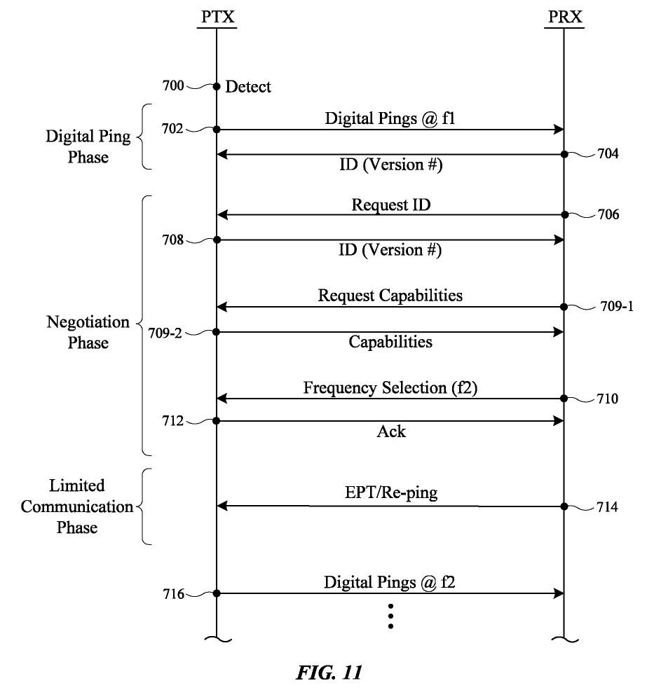

FIG. 11 is a diagram showing illustrative operations that can be performed between a PTX device 12 having wireless charging standard version number C and supporting wireless power transfer at only frequency f2 and a PRX device 24 having wireless charging standard version number C and supporting wireless power transfer at only frequency f2 in accordance with some embodiments. Here, devices 12 and 24 can perform frequency negotiations that ultimately result in the system reaching the active wireless power transfer phase using the common frequency f2 that is supported by both devices.

At block 700, the PTX device 12 can detect the presence of the PRX device 24. Block 700 of FIG. 11 may thus correspond to the operations of block 102 in FIG. 4.

At block 702, the PTX device 12 can output digital pings that are modulated at an active frequency. The active frequency can be initialized to frequency f1, assuming no prior frequency negotiation has been performed with device 24. In such scenario, the power contract element of each device can be set to a default value of “0.” Block 702 can thus correspond to the operations of block 106 of FIG. 4. At block 704, device 24 can send an ID packet that includes its wireless charging standard version number to device 12. In this example, device 24 can have a wireless charging standard version number C (see FIG. 3). Block 704 can thus correspond to the operations of block 108 of FIG. 4. Blocks 702 and 704 can thus be performed during the digital ping phase.

At block 706, the PRX device 24 can send a packet requesting an ID packet from the PTX device 12. At block 708, device 12 can respond by sending an ID packet that includes its wireless charging standard version number to device 24. In this example, device 12 can have a wireless charging standard version number C (see FIG. 3). Blocks 706 and 708 may correspond to the operations of block 112 in FIG. 4.

At block 709-1, the PRX device 24 can send a packet requesting a capabilities packet from the PTX device 12. At block 709-2, device 12 can respond by sending a capabilities packet (e.g., an extended capabilities packet) to device 24. The capabilities packet can include information such as one or more support frequencies for the wireless power transfer phase, one or more power limit reason, or other power-related information as described in connection with FIG. 5. Blocks 709-1 and 709-2 may correspond to the operations of block 114 in FIG. 4.

At block 710, device 24 can send a frequency selection packet to device 12. Here, the frequency selection packet sent by device 24 may include a frequency selector field having the second value (e.g., “1”), corresponding to a requested frequency of f2, since it is the only option listed in the capabilities packet. At block 712, device 12 can send an acknowledgement back to device 24, indicating that device 12 has accepted the frequency specified by the frequency selector field. Blocks 710 and 712 may correspond to the operations of block 116 in FIG. 4. Blocks 706, 708, 709-1, 709-2, 710, and 712 can thus be performed during the negotiation phase.

Although not explicitly shown FIG. 7, devices 12 and 24 can then perform the operations of blocks 118 and 120 in FIG. 4 towards the end of the negotiation phase. Here, both devices 12 and 24 will update their power contract element to a value of “1” as specified by the frequency selector field, which corresponds to a power contract frequency of f2. Both devices 12 and 24 can then check whether the current active frequency matches the power contract frequency. Since the current active frequency is still f1 by default and since the power contract frequency is now set to f2, the active frequency will be mismatched from the power contract frequency. As a result, the system can then proceed to the limited communication phase.

At block 714, the PRX device 24 may send one or more EPT/re-ping packet(s) to the PRX device 12. This will terminate the current wireless power transfer session and direct device 12 to restart the digital ping phase using an updated active frequency. Block 714 may thus correspond to the operations of block 124 during the limited communication phase.

At block 716, the PTX device 12 can output digital pings that are modulated at an updated active frequency. The active frequency will now be set equal to f2 in accordance with the updated power contract element. Block 716 can thus correspond to the operations of block 106 of FIG. 4. At this point, the remaining blocks 350 of FIG. 7 (e.g., including blocks 318, 320, 322, and 324) can be performed to reach the active wireless power transfer phase. In summary, devices 12 and 24 can perform frequency negotiations that ultimately result in the system reaching the active wireless power transfer phase using the common frequency f2 that is supported by both devices.

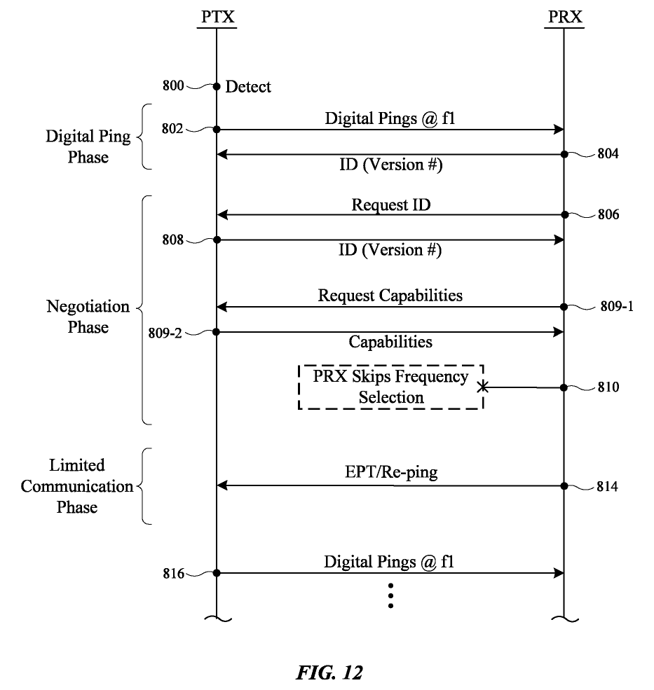

FIG. 12 is a diagram showing illustrative operations that can be performed between a PTX device 12 having wireless charging standard version number C and supporting wireless power transfer at only frequency f1 and a PRX device 24 having wireless charging standard version number C and supporting wireless power transfer at only frequency f2 in accordance with some embodiments. Device 24 can, however support wireless power transfer at frequency f1 when operating in accordance with the older wireless charging standard version number A.

At block 800, the PTX device 12 can detect the presence of the PRX device 24 on its charging surface. Block 800 of FIG. 12 may thus correspond to the operations of block 102 in FIG. 4.

At block 802, the PTX device 12 can output digital pings that are modulated at an active frequency. The active frequency can be initialized to frequency f1, assuming no prior frequency negotiation has been performed with device 24. In such scenario, the power contract element of each device can be set to a default value of “0.” Block 802 can thus correspond to the operations of block 106 of FIG. 4. At block 804, device 24 can send an ID packet that includes its wireless charging standard version number to device 12. In this example, device 24 can have a wireless charging standard version number C (see FIG. 3). Block 804 can thus correspond to the operations of block 108 of FIG. 4. Blocks 802 and 804 can thus be performed during the digital ping phase.

At block 806, the PRX device 24 can send a packet requesting an ID packet from the PTX device 12. At block 808, device 12 can respond by sending an ID packet that includes its wireless charging standard version number to device 24. In this example, device 12 can have a wireless charging standard version number C (see FIG. 3). Blocks 806 and 808 may correspond to the operations of block 112 in FIG. 4.

At block 809-1, the PRX device 24 can send a packet requesting a capabilities packet from the PTX device 12. At block 809-2, device 12 can respond by sending a capabilities packet (e.g., an extended capabilities packet) to device 24. The capabilities packet can include information such as one or more support frequencies for the wireless power transfer phase, one or more power limit reason, or other power-related information as described in connection with FIG. 5. In this example, the capabilities packet may list the frequency f1 as the only supported operating frequency while providing operating frequency preferences as the power limit reason. Blocks 809-1 and 809-2 may correspond to the operations of block 114 in FIG. 4.

At block 810, the PRX device 24 might intentionally skip the frequency selection block since it knows that it cannot support operation at frequency f1 specified by the capabilities packet. Without the frequency selection packet, the power contract element in both devices 12 and 24 will not be updated from their default value of “0.” Since the power contract element has not been set, the system will enter the limited communication phase in accordance with the truth table of FIG. 6.

At block 814, the PRX device 24 may send one or more EPT/re-ping packet(s) to the PRX device 12. This will terminate the current wireless power transfer session and direct device 12 to restart the digital ping phase using an updated active frequency. Block 814 may thus correspond to the operations of block 124 during the limited communication phase. Here, however, the active frequency will remain at the default value of f1 since the power contract element was not updated by a frequency selection packet.

At block 816, the PTX device 12 can output digital pings that are modulated again at an active frequency equal to f1 (e.g., processing effectively loops back to block 802). Here, the system may be stuck in a continuous loop that never enters the active wireless power transfer phase due to incompatible charging frequencies. In such scenarios, the PRX device 24 should avoid activating a charging status indicator on its display. Alternatively, the PRX device 24 can pretend to behave like a power receiving device operating in accordance with wireless charging standard version number A to fall back on wireless charging at frequency f1. For example, device 24 can subsequently send an ID packet reporting version number A after re-ping, effectively asking the PTX device 12 to operate in a backward compatibility mode using frequency f1.

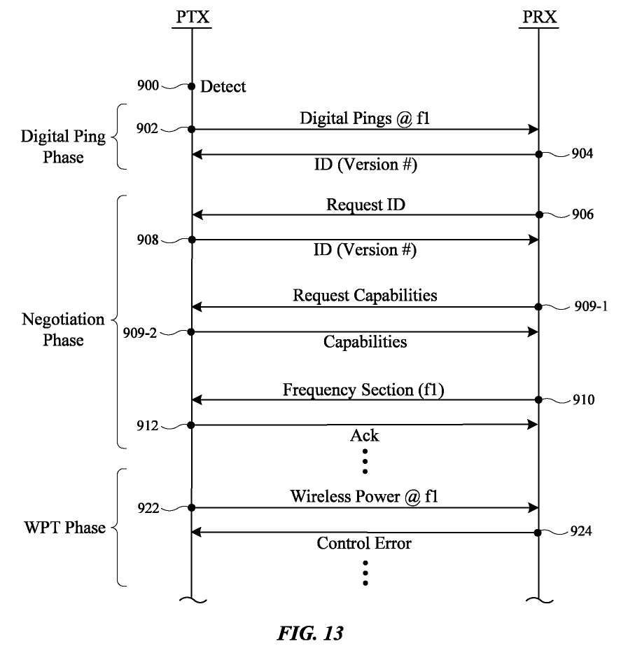

FIG. 13 is a diagram showing illustrative operations that can be performed between a PTX device 12 having wireless charging standard version number C and supporting wireless power transfer at only frequency f1 and a PRX device 24 having wireless charging standard version number C and supporting wireless power transfer at only frequency f1 in accordance with some embodiments. Here, devices 12 and 24 can perform frequency negotiations that ultimately result in the system reaching the active wireless power transfer phase using the common frequency f1 that is supported by both devices.

At block 900, the PTX device 12 can detect the presence of the PRX device 24 on its charging surface. Block 900 of FIG. 11 may thus correspond to the operations of block 102 in FIG. 4.

At block 902, the PTX device 12 can output digital pings that are modulated at an active frequency. The active frequency can be initialized to frequency f1, assuming no prior frequency negotiation has been performed with device 24. In such scenario, the power contract element of each device can be set to a default value of “0.” Block 902 can thus correspond to the operations of block 106 of FIG. 4. At block 904, device 24 can send an ID packet that includes its wireless charging standard version number to device 12. In this example, device 24 can have a wireless charging standard version number C (see FIG. 3). Block 904 can thus correspond to the operations of block 108 of FIG. 4. Blocks 902 and 904 can thus be performed during the digital ping phase.

At block 906, the PRX device 24 can send a packet requesting an ID packet from the PTX device 12. At block 908, device 12 can respond by sending an ID packet that includes its wireless charging standard version number to device 24. In this example, device 12 can have a wireless charging standard version number C (see FIG. 3). Blocks 906 and 908 may correspond to the operations of block 112 in FIG. 4.

At block 909-1, the PRX device 24 can send a packet requesting a capabilities packet from the PTX device 12. At block 909-2, device 12 can respond by sending a capabilities packet (e.g., an extended capabilities packet) to device 24. The capabilities packet can include information such as one or more support frequencies for the wireless power transfer phase, one or more power limit reason, or other power-related information as described in connection with FIG. 5. In this example, the capabilities packet may list the frequency f1 as the only supported operating frequency while providing operating frequency preferences as the power limit reason. Blocks 909-1 and 909-2 may correspond to the operations of block 114 in FIG. 4.

At block 910, device 24 can send a frequency selection packet to device 12. Here, the frequency selection packet sent by device 24 may include a frequency selector field having the third value (e.g., “2”), corresponding to a requested frequency of f1, since it is the only option listed in the capabilities packet. At block 912, device 12 can send an acknowledgement back to device 24, indicating that device 12 has accepted the frequency specified by the frequency selector field. Blocks 910 and 912 may correspond to the operations of block 116 in FIG. 4. Blocks 906, 908, 909-1, 909-2, 910, and 912 can thus be performed during the negotiation phase.

Although not explicitly shown FIG. 13, devices 12 and 24 can then perform the operations of blocks 118 and 120 in FIG. 4 towards the end of the negotiation phase. Here, both devices 12 and 24 will update their power contract element to a value of “2” as specified by the frequency selector field, which corresponds to a power contract frequency of f1. Both devices 12 and 24 can then check whether the current active frequency matches the power contract frequency. Since the current active frequency is still f1 by default and since the power contract frequency is now also set to f1, the active frequency will match the power contract frequency. As a result, the system can then proceed to the active wireless power transfer phase.

During the wireless power transfer phase, PTX device 12 can output wireless power to PRX device 24 (see block 922). Block 922 may thus correspond to the operations of block 130 in FIG. 4. During the wireless power transfer phase, device 24 can also send one or more control error packets for adjusting the output power level of the wireless power transfer (see block 924). Additionally or alternatively, other types of control or data packets can be conveyed between devices 12 and 24 during the wireless power transfer phase to help optimize the wireless power transfer operation. In summary, devices 12 and 24 can perform frequency negotiations that result in the system reaching the active wireless power transfer phase using the common (fallback) frequency f1 that is supported by both devices.

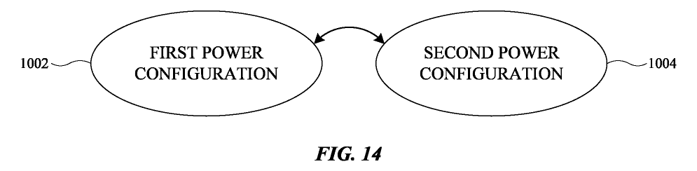

FIG. 14 is a state diagram showing different power configurations for PTX 12. As shown in FIG. 14, PTX 12 may be operable in a first power configuration 1002 and a second power configuration 1004. In the first power configuration 1002, PTX 12 may have a first maximum negotiable power transfer level (sometimes referred to as first negotiable load power). In the second power configuration 1004, PTX 12 may have a second maximum negotiable power transfer level (sometimes referred to as second negotiable load power) that is greater than the first maximum power transfer level. PTX 12 may also have a potential maximum power transfer level (sometimes referred to as potential load power). The potential load power may be greater than the first negotiable load power of the first power configuration 1002 and may be equal to the second negotiable load power of the second power configuration 1004.

The potential load power is the rated maximum supported load power for PTX 12. The negotiable load power is the maximum currently available load power for PTX 12 based on the current operating conditions of the wireless power transfer system. In ideal conditions (as in the second power configuration 1004), the negotiable load power is equal to potential load power. However, in some circumstances (as in the first power configuration 1002) the negotiable load power may be less than the potential load power. Reasons for the negotiable load power being less than the potential load power include foreign object presence, brown-out protection, over-temperature, maximum inverter voltage reached, over current, maximum available power from a power source, selected operating frequency, pending power configuration change, etc.

In one illustrative example, the first power configuration 1002 includes operating inverter 60 in a half-bridge mode of operation and the second power configuration 1004 includes operating inverter 60 in a full-bridge mode of operation. Inverter 60 may actively switch four switching transistors in the full-bridge mode of operation and only two switching transistors in the half-bridge mode of operation. The full-bridge mode of operation may provide inverter 60 with a higher maximum output voltage and power than the half-bridge mode of operation.

In another illustrative example, the first power configuration 1002 includes using a first power source for power transmitting circuitry 52 and the second power configuration 1004 includes using a second, different power source for power transmitting circuitry 52. The first power source may be a battery or other charge storage device within PTX 12. The second power source may be a wired power source (e.g., a wired connection to a wall outlet, an AC-DC power converter, etc.).

These examples for the different power configurations are merely illustrative. Any desired parameter or operating mode for PTX 12 (e.g., within power transmitting circuitry 52, input-output devices 62, control circuitry 16, etc.) may be changed between the different power configurations. The example of two power configurations shown in FIG. 14 is merely illustrative. PTX 12 may be operable in any desired number of power configurations.

PTX 12 may switch between the first power configuration and the second configuration during negotiation phase 110 and/or wireless power transfer phase 128. In one example, a PTX may operate in the first power configuration (with the first negotiable load power) during negotiation phase 110 and at the beginning of wireless power transfer phase 128. Subsequently, during wireless power transfer phase 128, the PTX may switch from the first power configuration to the second power configuration (with the second negotiable load power). After switching to the second power configuration, the PTX has a higher negotiable load power and the power transfer level may be increased.

PRX 24 may configure power receiving circuitry 54 (e.g., coil(s) 48 and/or rectifier 50) based on the power level delivered by PTX 12. In the aforementioned example where PTX 12 operates in the first power configuration (with the first negotiable load power) during negotiation phase 110, the negotiable load power is less than the potential load power at the beginning of the wireless power transfer phase 128. In the absence of additional information, PRX 24 may assume that the negotiable load power will be less than the potential load power indefinitely and configure (e.g., optimize) power receiving circuitry 54 accordingly. However, PTX 12 may switch from the first power configuration to the second power configuration shortly after the beginning of the wireless power transfer phase 128.

When PTX 12 will, within a relatively short period of time, switch to the second power configuration with the second negotiable load power, PTX 12 may provide one or more communications to PRX 24 that identifies a pending configuration change as the reason for the negotiable load power being less than the potential load power, so as to advise PRX 24 against optimizing power receiving circuitry 54 for the first negotiable load power (or, more generally speaking, operating characteristics that are less consistent with the soon to be provided second negotiable load power). To carry out this communication, PTX 12 and PRX 24 may follow a wireless power transfer protocol that defines a duration of time after communicating the pending configuration change within which PTX 12 should change from the first power configuration to the second power configuration. PRX 24 may therefore, in response to receiving the communication of a pending configuration change as the reason for the negotiable load power being less than the potential load power, hold off on configuring the power receiving circuitry for the first negotiable load power and instead wait until PTX 12 switches into the second power configuration with the second negotiable load power. After PTX 12 switches into the second power configuration with the second negotiable load power, PRX 24 may configure the power receiving circuitry for the second negotiable load power.

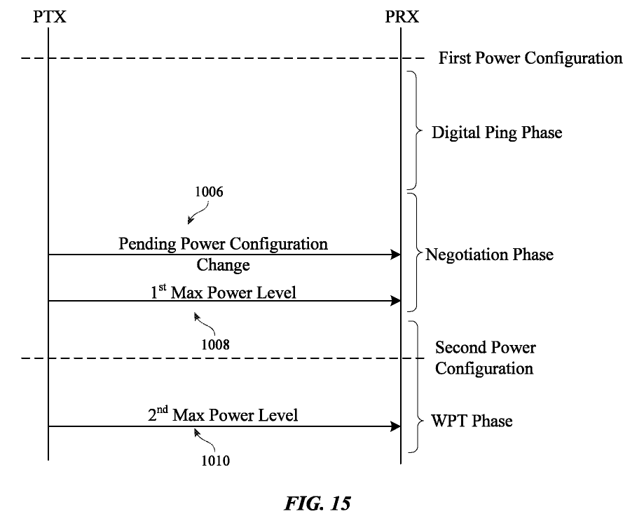

FIG. 15 is a diagram showing illustrative operations that can be performed between a power transmitting device 12 and a power receiving device 24. As shown in FIG. 15, PTX may be in a first power configuration during a digital ping phase and a negotiation phase. During the negotiation phase, PTX 12 may transmit first information 1006 to PRX 24 that identifies a pending power configuration change. PTX 12 may also transmit second information 1008 to PRX 24 that identifies a first negotiable load power (sometimes referred to as a first maximum negotiable power transfer level). The first negotiable load power may be less than the potential load power for PTX 12.

PRX 24 may identify from information 1006 and/or 1008 that the first negotiable load power from information 1008 is less than the potential load power due to the pending power configuration change identified by information 1006. The identification of the pending power configuration change by PTX 12 may have an associated duration of time during which PTX 12 will execute the pending power configuration change. The duration of time may be a predetermined duration of time defined by the wireless power transfer protocol implemented by PTX 12 and PRX 24. Alternatively, the duration of time may be identified by PTX 12 in a data packet transmitted to PRX 24. For example, a data packet that identifies the pending power configuration change may also include information identifying the duration of time during which PTX 12 will execute the pending power configuration change.

The duration of time may be between 2 and 20 seconds, less than 20 seconds, less than 10 seconds, less than 5 seconds, greater than 1 second, greater than 2 seconds, etc. PRX 24 may therefore configure power receiving circuitry 54 based on the understanding that PTX 12 will execute the pending power configuration change within the duration of time. PRX 24 may, for example, hold off on changing the configuration of power receiving circuitry 54 until receiving confirmation from PTX 12 that the pending power configuration change has been executed (or receiving information from PTX 12 indicating an increase in the negotiable load power).

After transmitting information 1006 and information 1008, PTX 12 and PRX 24 may enter the wireless power transfer phase. During the wireless power transfer phase and after transmitting information 1006 and information 1008 to PRX 24, PTX 12 may switch from the first power configuration to the second power configuration. In other words, PTX 12 executes the pending power configuration change identified by information 1006. In the second power configuration, the negotiable load power for PTX 12 may be greater than the negotiable load power in the first power configuration. Accordingly, PTX 12 may, once the PTX is in the second power configuration, transmit information 1010 that identifies a second negotiable load power (sometimes referred to as a second maximum negotiable power transfer level). The second negotiable load power may be greater than the first negotiable load power from information 1008 and may be equal to the potential load power for PTX 12.

Information 1006, 1008, and 1010 may be transmitted by PTX 12 in one or more data packets. The information may be transmitted using in-band communication (e.g., using FSK modulation while transferring wireless power). Alternatively, the information may be transmitted using out-of-band communication if desired. Information 1006 and 1008 may be part of different data packets or may be part of the same data packet.

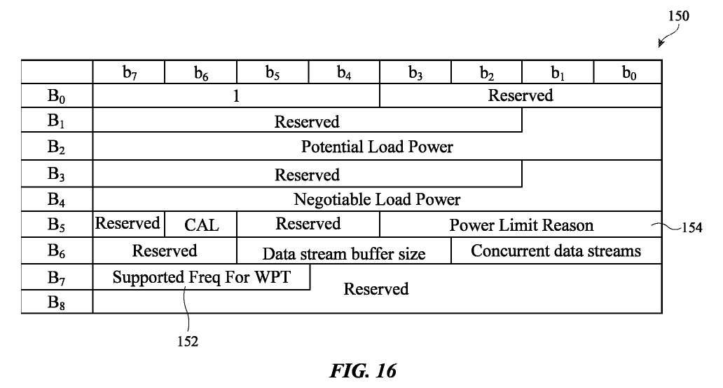

In one example, information 1006, 1008, and 1010 are included in capabilities packets such as capabilities packet 150 from FIG. 5. FIG. 16 is a diagram of an illustrative capabilities packet that includes a potential load power, a negotiable load power, a power limit reason, and a supported frequency for the wireless power transfer phase. The packet in FIG. 16 is a device capabilities packet 150 similar to as shown and discussed in connection with FIG. 5. As shown, packet 150 includes bytes B₀-B₈with each byte including 8 bits b₀-b₇. The packet includes one or more bits (e.g., in bytes B₁ and B₂) that represent the potential load power for PTX 12. The packet also includes one or more bits (e.g., in bytes B₃ and B₄) that represent the negotiable load power for PTX 12.

Packet 150 also includes a field 154 with one or more bits (e.g., in byte B₅) that represent a power limit reason. The one or more bits may convey a code that is associated with a respective power limit reason. For example, the code for the power limit reason bits may be 0 when the negotiable load power is equal to potential load power (and power is not limited). The code for the power limit reason bits may be non-zero (e.g., a code between 1 and 15) when the negotiable load power is less than the potential load power (and power is therefore limited). Each non-zero code may have an assigned reason for the power limit (e.g., foreign object presence, brown-out protection, over-temperature, maximum inverter voltage reached, over current, maximum available power from a power source, selected operating frequency, pending power configuration change, etc.).

FIG. 16 shows field 152 for packet 150 in bits b₅-b₇ of byte B₇. As previously discussed, field 152 may list one or more supported frequencies for the active wireless power transfer phase. Packet 150 may also include one or more bits (e.g., CAL at byte B₅ and bit b₆) that identify whether or not a power loss calibration protocol (which may be used for foreign object detection) is supported, one or more bits (e.g., at byte B₆ and bits b₅-b₃) that represent the size of a data stream buffer, and one or more bits (e.g., at byte B₆ and bits b₂-b₀) that represent the maximum number of concurrent data streams the power transmitter can handle.

In general, the locations of the various fields in FIG. 16 are merely illustrative and packet 150 may include any desired number of fields in any desired order and bit locations.

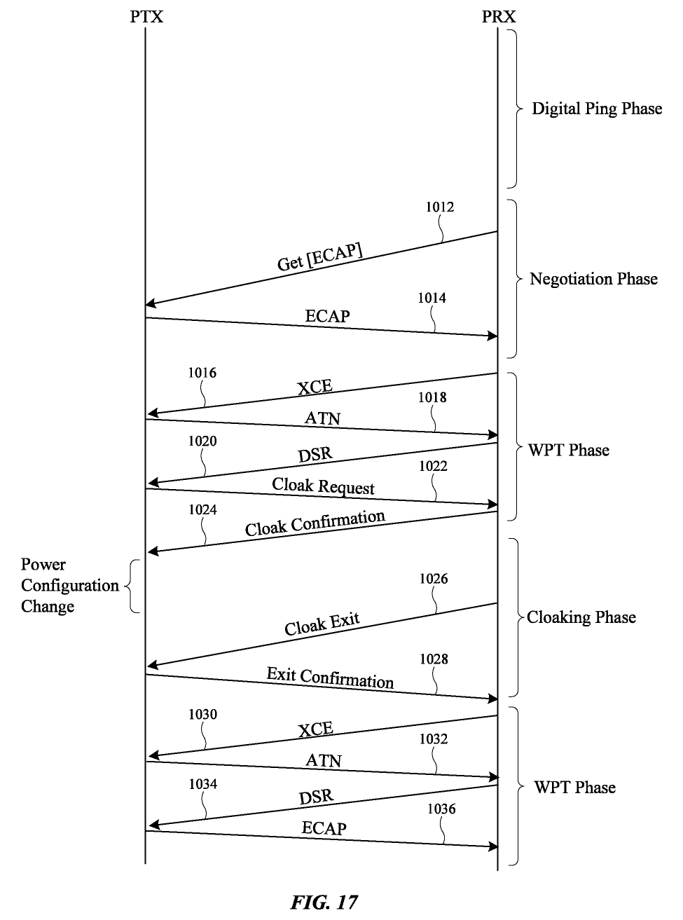

FIG. 17 is a diagram showing illustrative operations that can be performed between a power transmitting device 12 and a power receiving device 24 when PTX 12 uses a capabilities packet to identify a pending power configuration change. In this example, the pending power configuration change is a change from operating inverter 60 in the half-bridge mode of operation in the first power configuration to operating inverter 60 in the full-bridge mode of operation in the second power configuration. Transmission of wireless power may be paused during the power configuration change. PTX 12 and PRX 24 may therefore enter a cloaking phase while the power configuration change is executed.

The wireless power transfer protocol implemented by PTX 12 and PRX 24 may dictate that PTX 12 operates inverter 60 in the half-bridge mode of operation during digital ping phase 104 and negotiation phase 110. However, PTX 12 may subsequently switch to operating inverter 60 in the full-bridge mode during the wireless power transfer phase.

As shown in FIG. 17, PRX 24 may transmit a packet 1012 (sometimes referred to as GET[ECAP] packet 1012) to PTX 12 requesting that PTX 12 sends a capabilities packet to PRX 24. PTX 12 may subsequently send ECAP packet 1014 to PRX 24. ECAP packet 1014 may identify a potential load power, a first negotiable load power that is less than the potential load power, and a power limit reason 154 that identifies a pending power configuration change as the reason for the first negotiable load power being less than the potential load power.

PRX 24 may receive the ECAP packet 1014. PTX 12 and PRX 24 may then commence a wireless power transfer phase during which the load power is less than or equal to the first negotiable load power from ECAP packet 1014.

PRX 24 may have a first configuration for power receiving circuitry 54 that is associated with (e.g., optimized for) the first negotiable load power. However, in this example the pending power configuration change is identified as the power limit reason and the pending power configuration change is defined by the wireless power transfer protocol as a temporary condition. Because the power limit condition is temporary, PRX 24 may not reconfigure power receiving circuitry 54 into the first configuration even when PTX 12 operates using the first negotiable load power at the start of the wireless power transfer phase.

During the wireless power transfer phase, PRX 24 transmits a control error packet 1016 (sometimes referred to a CE packet 1016 or XCE packet 1016) to PTX 12. To initiate a cloaking phase, PTX 12 may respond to the XCE packet with an attention packet 1018. The attention packet may indicate to PRX 24 that PTX 12 has additional information to transmit to PRX 24. PRX 24 responds to the attention packet with data stream response (DSR) packet 1020, which allows PTX 12 to transmit the desired information to PRX 24. PTX 12 subsequently transmits a cloak request packet 1022 to PRX 24. The cloak request is a request to start a cloaking phase during which transmission of wireless power is temporarily paused. PRX 24 may transmit a cloaking confirmation packet 1024 to PTX 12 after which the wireless power transfer phase is temporarily paused and the cloaking phase commences.

During the cloaking phase, PTX 12 may execute the pending power configuration change identified in packet 1014. In this example, PTX 12 may switch from operating inverter 60 in a half-bridge mode to operating inverter 60 in a full-bridge mode during the power configuration change.

After the power configuration change is complete, PTX 12 may resume transmitting wireless power to PRX 24 (now with inverter 60 in the full-bridge mode of operation). The load power may still be the same as at the start of the cloaking phase. After PTX 12 resumes transmitting the wireless power, a cloaking exit sequence may be performed where PRX 24 transmits a cloak exit packet 1026 to PTX 12 and PTX 12 responds with a cloak exit confirmation packet 1028 to PRX 24. The cloaking phase is then terminated and the wireless power transfer phase resumes.

After resuming the wireless power transfer phase, PRX 24 may transmit a control error packet 1030 to PTX 12. PTX 12 may respond to the XCE packet 1030 with an attention packet 1032. The attention packet may indicate to PRX 24 that PTX 12 has additional information to transmit to PRX 24. PRX 24 responds to the attention packet with DSR packet 1034, which allows PTX 12 to transmit the desired information to PRX 24. PTX 12 then transmits a new capabilities packet 1036 to PRX 24.

Capabilities packet 1036 is transmitted while PTX 12 is in the second power configuration. Capabilities packet 1036 identifies the same potential load power as capabilities packet 1014 (which was transmitted while PTX 12 was in the first power configuration). However, capabilities packet 1036 identifies a second negotiable load power that is greater than the first negotiable load power from packet 1014. The second negotiable load power may be equal to the potential load power. There is therefore no power limit reason identified by field 154 in packet 1036 (e.g., the code for the power limit reason bits in packet 1036 is 0 indicating that the negotiable load power is equal to potential load power and power is not limited).

PRX 24 may have a second configuration for power receiving circuitry 54 that is associated with (e.g., optimized for) the second negotiable load power. After receiving ECAP packet 1036 identifying the second negotiable load power, PRX 24 may negotiate an increase in the load power (e.g., raising the load power to be equal to the second negotiable load power) and/or may reconfigure power receiving circuitry 54 into the second configuration.

It should be noted that in an alternate example, PRX 24 may receive an ECAP packet with a power limit reason other than the pending power configuration change. In this case, PRX 24 may configure power receiving circuitry 54 into a configuration that is associated with (e.g., optimized for) the negotiable load power identified by the ECAP packet. Only when PRX 24 receives an ECAP packet identifying the power configuration change as the power limit reason does PRX 24 hold off on configuring the power receiving circuitry for the negotiable load power identified by the ECAP packet (because the pending power configuration change is known to be a temporary power limit reason).

In FIG. 17, the identified packets may be transmitted using in-band communication. As one example, FSK modulation may be used by PTX 12 to transmit packets 1014, 1018, 1022, 1028, 1032, and 1036 to PRX 24 and ASK modulation may be used by PRX 24 to transmit packets 1012, 1016, 1020, 1024, 1026, 1030, and 1034 to PTX 12. This example is merely illustrative and the packets may be transmitted using any desired techniques.

The operations described in connection with FIGS. 4, 7-13, 15, and 17 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

The foregoing is merely illustrative and various modifications can be made to the described embodiments. The foregoing embodiments may be implemented individually or in any combination.

What is claimed is:

1. A power receiving device adapted to receive wireless power from a power transmitting device, the power receiving device comprising:
a wireless power transfer coil configured to receive wireless power from the power transmitting device, wherein the power transmitting device implements a wireless power transfer protocol defining a first power profile and a second power profile, and wherein the power transmitting device transfers wireless power at a first wattage during operation under the first power profile and transfers wireless power at a second wattage greater than the first wattage during operation under the second power profile;
a rectifier circuit coupled to the wireless power transfer coil and configured to output a corresponding rectified voltage; and
control circuitry configured to:
in response to determining that the power transmitting device is capable of transmitting wireless power at multiple frequencies during operation under the second power profile, select a particular frequency from the multiple frequencies and send a request to the power transmitting device requesting the power transmitting device to transmit wireless power at the particular frequency, wherein the particular frequency is selected according to a geographic assignment for the power receiving device.

2. The power receiving device of claim 1, wherein the control circuitry is further configured to determine the geographic assignment for the power receiving device by determining a location of the power receiving device using a global positioning system (GPS) or by looking up a unique identifier stored on the power receiving device.

3. The power receiving device of claim 1, wherein the first wattage is equal to 5 watts, and wherein the second wattage is up to 15 watts or more.

4. The power receiving device of claim 3, wherein:
the first power profile comprises the Baseline Power Profile (BPP) as defined by the Qi wireless power transfer protocol established by the Wireless Power Consortium (WPC); and
the second power profile comprises the Magnetic Power Profile (MPP) as defined by the Qi wireless power transfer protocol.

5. The power receiving device of claim 4, wherein the multiple frequencies supported by the power transmitting device during operation under the second power profile comprises 128 kHz and 360 kHz, and wherein the particular frequency is equal to 128 kHz.

6. The power receiving device of claim 1, wherein the control circuitry is further configured to:
determine that the power transmitting device is capable of transmitting wireless power at the multiple frequencies during operation under the second power profile by examining an extended capabilities packet received from the power transmitting device.

7. The power receiving device of claim 6, wherein the control circuitry is further configured to:
in response to determining that a power limit reason field in the extended capabilities packet has a predetermined value, send a request to the power transmitting device requesting the power transmitting device to transmit wireless power at another frequency of the multiple frequencies that is greater than the particular frequency.

8. A power transmitting device configured to transmit wireless power to a power receiving device, the power transmitting device comprising:
a wireless power transfer coil configured to transmit wireless power to the power receiving device;
an inverter configured to supply alternating-current drive signals to the wireless power transfer coil; and
control circuitry configured to:
transmit, using the wireless power transfer coil, a first data communication packet to the power receiving device, wherein the first data communication packet identifies a first maximum power transfer level and a pending power configuration change;
within a predetermined duration of time from transmitting the first data communication packet, perform the pending power configuration change; and
within the predetermined duration of time from transmitting the first data communication packet, transmit, using the wireless power transfer coil, a second data communication packet to the power receiving device, wherein the second data communication packet identifies a second maximum power transfer level that is greater than the first maximum power transfer level.

9. The power transmitting device of claim 8, wherein performing the pending power configuration change comprises:
transmitting, using the wireless power transfer coil, a third data communication packet to the power receiving device, wherein the third data communication packet comprises a cloaking request;
receiving, using the wireless power transfer coil, a fourth data communication packet from the power receiving device, wherein the fourth data communication packet confirms the cloaking request; and
after receiving the fourth data communication packet from the power receiving device, stopping transmission of wireless power to the power receiving device.

10. The power transmitting device of claim 9, wherein performing the pending power configuration change comprises performing the pending power configuration change while transmission of wireless power to the power receiving device is stopped.

11. The power transmitting device of claim 8, wherein the power transmitting device and the power receiving device implement a wireless power transfer protocol and wherein the predetermined duration of time is defined by the wireless power transfer protocol.

12. The power transmitting device of claim 11, wherein the predetermined duration of time is between 2 seconds and 20 seconds.

13. The power transmitting device of claim 8, wherein performing the pending power configuration change comprises changing the inverter from a half-bridge mode of operation to a full-bridge mode of operation.

14. The power transmitting device of claim 8, wherein performing the pending power configuration change comprises changing a power source for the inverter.

15. The power transmitting device of claim 8, wherein the first data communication packet identifies the pending power configuration change as a reason for a limited maximum power transfer level.

16. The power transmitting device of claim 15, wherein the first data communication packet identifies a potential load power and a negotiable load power that is lower than the potential load power.

17. The power transmitting device of claim 16, wherein the second data communication packet identifies the potential load power and an additional negotiable load power that is equal to the potential load power.

18. The power transmitting device of claim 8, wherein the power transmitting device and the power receiving device implement a wireless power transfer protocol and wherein the first and second data communication packets are extended power transmitter extended capabilities packets defined by the wireless power transfer protocol.

19. A power transmitting device configured to transmit wireless power to a power receiving device, the power transmitting device comprising:
a wireless power transfer coil configured to transmit wireless power to the power receiving device;
an inverter configured to supply alternating-current drive signals to the wireless power transfer coil; and
control circuitry configured to:
determine an operating location for the power transmitting device; and
select one of multiple supported wireless power transmission frequencies for the alternating-current drive signals based on the determined operating location.
